(19) United States
(12) Patent Application Publication
(10) Pub. No.: US 2007/0043613 A1
(43) Pub. Date: Feb. 22, 2007

(54) Facilitating E-commerce and customer retention

(75) Inventor: Brian L. Longest, Chantilly, VA (US)

Correspondence Address: Brian Longest, 42257 Providence Ridge Drive, Chantilly, VA, 20152, US

(73) Assignee: Ricochet Communications, LLC, Reston, VA (US)

(21) Appl. No.: 11/206,921

(22) Filed: Aug. 19, 2005

(51) Int. Cl. G06Q 30/00

(52) U.S. Cl. 705/14

(57) ABSTRACT

E-commerce is growing at a rapid pace due to the fantastic growth rate of the Internet. Consumers are becoming more Internet savvy and more likely to spend money over the Internet. The present invention allows the Customer to receive a cash credit to their account, as well as other reward alternatives. Receiving cash in the Customers account with the Merchant leaves no ambiguity as to what the Customer can purchase, as they can purchase anything at the Merchants site. The present invention relates to electronic commerce (e-commerce) and the purchasing of goods and services. More particularly to Customer retention and loyalty programs, and still more particularly to creating the ideal Customer retention and loyalty program by facilitating the exchange between online Advertisers, Merchants, and Consumers.

### RELATED APPLICATION

This application claims the benefit of U.S. Provisional Application Ser. No. US60/602,121, filed Aug. 18, 2004 and entitled “Facilitating E-Commerce and Customer Retention”.

### FIELD OF THE INVENTION

The present invention relates to electronic commerce (e-commerce) and the purchasing of goods and services. More particularly to Customer retention and loyalty programs, and still more particularly to creating the ideal Customer retention and loyalty program by facilitating the exchange between online Advertisers, Merchants, and Consumers.

### BACKGROUND OF THE INVENTION

Definitions

“Network”: websites, e-mail communications, and other forms of online advertising, that have been grouped together in an effort to maximize the audience for an Advertiser's advertisement across multiple websites or e-mail communications.

“Online Store”: a store on the Internet that a Consumer can purchase goods or services from.

“Merchant”: an owner of an online store and may also own a traditional brick and mortar store.

“Advertiser”: an individual or entity that advertises online, and possibly offline, their product or service for sale. In many instances a Merchant is also an Advertiser.

“Offer”: an Advertisement typically includes an Offer, either to purchase a particular good and/or service, or to take advantage of a free trial period of a particular good and/or service, possibly receive the good and/or service only for the price of shipping and handling, and other possible Offers.

“Consumer”: an individual and/or business.

“Customer”: a Consumer that has made at least one purchase from the Merchant.

E-commerce is growing at a rapid pace due to the fantastic growth rate of the Internet. Consumers are becoming more Internet savvy and more likely to spend money over the Internet.

Customer loyalty and retention has become extremely difficult as the Internet allows Consumers to quickly search for the best price, regardless of the businesses geographical location since the item will be shipped when bought. Since Consumers can quickly find the best price on every item they need it is difficult for a Merchant to create loyalty to their online store without extensive marketing at a cost of both money and time. There is no guarantee that email newsletters to past Customers, coupons, product reviews, or other value added services and Customer communication from any Merchant will guarantee that a Consumer will revisit the Merchant's online store and also make a future purchase.

Multiple programs to achieve Customer retention and loyalty have been created and implemented. Customer retention and loyalty programs often fail due to the amount of effort that a Customer must put forth to obtain the points, or other form of rewards, from the Merchant. A Customer must then determine what the Customer can redeem the points on, purchase, and how the Customer can redeem the points. Both determining what the Customer can redeem the points on and how the Customer can redeem the points have lead to confusion and frustration on the part of the Customer thereby rendering the Customer retention and loyalty programs ineffective and short lived.

### FEATURES AND ADVANTAGES

The present invention allows the Customer to receive a cash credit to their account, as well as other reward alternatives. Receiving cash in the Customers account with the Merchant leaves no ambiguity as to what the Customer can purchase, as they can purchase anything at the Merchants site. There is also no ambiguity as to how the Customer redeems their credit, they simply purchase a product, or service, as usual and the credit is used at the time of checkout, no differently than if they used their credit card or other form of payment. The present invention creates the ideal Customer loyalty and retention program as the Customer has now received unambiguous cash as their reward, and the Merchant will receive repeat business from the Customer since the Customer now has a cash credit in their account with the Merchant.

The present invention also shortens, and creates a more efficient, online e-commerce life cycle. There are three major roles in e-commerce, that of Merchant, Advertiser and Customer, many times a Merchant is also an Advertiser and vice versa. In simple terms, an Advertiser places an advertisement on a website, in an e-mail, or throughout multiple websites and e-mails via an advertising Network that organizes the advertising space of multiple websites or newsletters together such as Double Click, Value Click, or others, and the Advertiser pays a fee for the advertisement or a fee when an Offer is completed by a Consumer, or in methods of paying for online advertising. A Consumer views and responds to an Advertisement, taking them to the Merchants website, where the Consumer makes a purchase and is now a Customer of the Merchants online business. Money has now flowed from an Advertiser to a Network then to the member of the Network whose site produced the conversion, in one transaction, and in a second transaction from the Customer to the Merchants online store. This cycle then repeats itself. The present Invention places the Advertisement on a Merchants site and the Customer takes advantage of the Offer. The money now flows from the Advertiser to the present Invention and then directly to the Merchant, which is more simplistic and efficient. Two things have taken place here. An Advertiser has had their Offer completed as the Customer took advantage of a third party Offer while at the Merchants site. The Customer also does not have to complete a transaction with the Merchant, by taking advantage of a third party Offer the money needed by the Customer to purchase an item from the Merchant has been provided by the Advertiser. Money has gone from one Advertiser directly to the Merchant and the Customer has received their product. The present Invention makes the above example, and more, possible.

An example of the present Invention is as follows. A Consumer visits a Merchants Online Store. After the Consumer completes a purchase the Merchant displays an Offer stating that the Consumer, now a Customer, can have a $20 credit added to their account with the Merchant if they take advantage of one of the following Offers. One of the Offers is for a free 30 day free trial to listen to music stations online. The Customer checks a box, or clicks through to a pop up window that has additional Offer details, to enroll in the free trial. The information is either sent directly from the Merchant to the present invention to the Advertiser of the 30 day free trial, or sent directly to the Advertiser of the 30 day free trial after providing the information the Advertiser needs. Either way the Advertiser has now received a sign up, conversion, for the 30 day free trial and the present invention has placed the Offer in front of the Customer through the Merchant, who is a member of the present invention's network, and the present invention has tracked exactly which Customer from exactly which Merchant has taken advantage of the Offer. Either immediately, or after Advertiser confirmation, the present invention will inform the Merchant that the Customer has complied with the terms of the Offer and provide cash for the transaction to the Merchant who then credits the Customer's account.

As a flow of funds example, the Advertiser pays a fee of $40 for the free trial sign up, the present invention takes a portion of the free trial sign up and the Merchant receives a portion of the $40, in which the Merchant can either credit the entire amount to the Customer's account or a portion thereby increasing their overall profitability. Merchant's may also award points, gifts, entries into sweepstakes or other rewards as opposed to a cash credit. Merchant's with traditional brick and mortar stores may credit a Customer's account that can be used at the brick and mortar store, provide a gift card or other form of credit.

Merchants may also either credit the Customer's account, which leads to increased Customer retention and loyalty since the Customer will return to redeem their credit, or the Merchant may opt to immediately credit the Customer's account thereby reducing the Customers overall cost, or possibly eliminating the need for the Customer to pay anything at all. Crediting a Customers account will greatly increase the chance that the Customer will return thereby increasing Customer retention and loyalty, while immediately crediting the amount toward the Customer's purchase will greatly increase sales.

Merchants may now take advantage of advertising without losing a Consumer or Customer. When a Merchant has a Consumer at their site they want the Consumer to stay at the site and make a purchase. Advertising third party stores, or sites, with banners or other forms of advertisements takes the visitor away from the Merchant's site and therefore Merchants rarely allow third party advertisements on their site. Due to this, Merchants have lost a stream of revenue that is prevalent online, third party advertising direct from other Merchants or Networks.

The present invention allows Merchants to add advertising to their website and not lose the Consumer, Customer, or the sale. When presented with an Offer after the sale, presenting an Offer at time of checkout, or allowing a pop up window to contain the Offer after a Customer has clicked a link, the Merchant has not lost the Customer since they have either already made a purchase or will return since the Customer's account with that Merchant has been credited with cash. With the present invention Merchants may now participate in advertising on their website that they never would allow before.

The present invention also increases the chance of conversions. A conversion occurs when a Consumer takes advantage of an Offer. With the present invention the Offers may be presented at a time when the Consumer is more likely to take advantage of them. If an Offer is presented at the point of sale, when the Customer has just, or is currently purchasing an item, then the Customer has their credit card in hand and is in the purchasing mood. A Consumer may purchase some makeup for $5 shipping and handling if they just purchased a book literally seconds ago, have their credit card in hand, and will receive a $20 credit in the Customer's account with the Merchant. This is due to the fact that Advertisers are now able to obtain a more qualified audience as the Customer may have just purchased an item and is therefore an individual that is not adverse to spending online.

The present invention, system and process, can be implemented in a variety of ways. One such embodiment is the following. A database which keeps information including, but not limited to the following, the Offers from Advertisers and the corresponding tracking code, the amount each Offer pays, all the Merchants participating in the present inventions program, all the Consumers that have visited an Offer page presented by the present invention or taken advantage of an Offer presented by the present invention, as well as all the Merchants that sent the Consumer to the Offer page, other tracking information such as IP addresses of Merchants, Consumers, Advertisers, time/date stamps, as well as customizable information such as which Offers a Merchant may or may not want to appear on the Offer page presented to their Consumers and/or Customers, and also data of which Offers convert allowing algorithms to be created which maximize conversions.

Each Merchant will receive at least one link, URL, to a web page. Such as http://www.website.com/Offerpage.php. The present invention allows each Merchant to send their Customers to the same web page, however by passing a unique identifier, a cookie on the Customers computer, or IP addresses, the Offers on the page as well as text on the page can be customized for that particular Merchant. Each Merchant can decide which Offers they do and do not want to appear, a Merchant who sells DVDs may not want other DVD Offers to appear on the page. Also, the present invention can present Offers based on whether or not the Customer has taken advantage of the particular Offer in the past or not. The present invention can also use algorithms to determine which Offers to present based on other variables such as day, time of day, geographic location of the Customer and/or the Advertiser, and various other variables to create algorithms which will increase conversions of the presented Offers. Once a Customer is sent to the Offer page the Merchant either sends a Unique identifier of the Customer, such as an e-mail address, or another identifier that has unique and traceable meaning to that particular Merchant. The combination of the Merchant's identifier and the Customer's identifier allow the present invention to track back the payment from the Advertiser to the correct Merchant and Customer of the Merchant for reconciliation purposes allowing the Merchant to credit the proper Customer's account.

The present invention creates web pages dynamically in real time from elements in the database, including but not limited to the Offer code and specific text such as slogans or the dollar amount rewarded for taking advantage of Offers, according to which Merchant, or other entity, that called the web page. The web page is presented to the Customer, and the Customer's visit is logged in the database as well as the time/date and which Merchant the Customer came from. The Customer then clicks through on an Offer, the code that the Customer clicked includes tracking elements, such as a unique identifier for that Merchant and Customer combination or a Merchant identifier and a separate Customer identifier. The present invention then retrieves confirmation from the Advertiser of each Offer that the particular Merchant and Customer combination has successfully complied with the terms of their Offer and the present invention receives the payment from the Advertiser, notifies the Merchant and supplies the payment along with the Customer identifier so the Customer that took advantage of a presented Offer may be properly credited.

Yet another variation does not include an Offer page, but code sent from the present invention to the Merchant which is included directly on one of the Merchant's web pages. This code presents various Offers to the Customer in real time, tracks the Customers actions, records the Customers actions, receives payment from the Advertiser of an Offer that the Customer took advantage of, receives payment from the Advertiser, and finally presents payment to the Merchant along with the unique Customer identifier.

In all examples, payment may be immediately applied to the Customer's account, thereby providing an immediate credit and/or free product or service, or as a credit for future purchases, alternatively as points, gifts, or other rewards.

Yet another embodiment allows a Consumer to go directly to the Offers, without first visiting a Merchants site, take advantage of an Offer and choose which Merchant to have the cash credit applied to. They may even choose from a list of products that can be shipped or even drop shipped via wholesalers.

### DRAWINGS

Three embodiments of the present invention are shown in the attached drawings.

FIG. 1 is a flow chart.

FIG. 2 is a flow chart.

FIG. 3 is a flow chart.

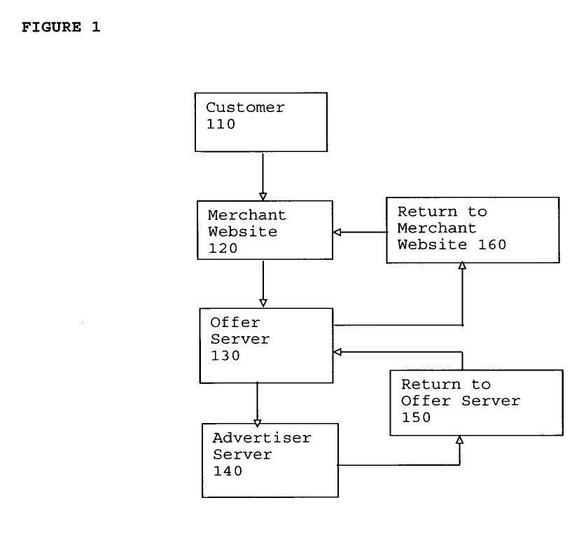

FIG. 1 begins with the Customer 110 visiting the Merchants website 120. The Merchants website 120 already has code with various Offers on their web page at the time of checkout, the code is provided by the present invention. This code presents an Offer and requests various pieces of information from the Customer 110 that is necessary to complete an Advertisers Offer. Once the Merchants website has obtained the necessary pieces of information collected from the Customer, the Merchants website sends the collected information to the Offer Server 130 along with unique identifying information for the Customer. Offer Server 130 presents the various pieces of information collected from the Customer, along with unique identifying information for both the Merchant and the Customer, to the Advertisers Server 140. Advertiser Server 140 returns to Offer Server in step 150 with the payment and the unique identifiers presented by the Offer Server for reconciliation. In step 160 the Offer server then returns to the Merchant the payment and the unique identifier originally presented by the Merchant for reconciliation and proper credit to the Customers account.

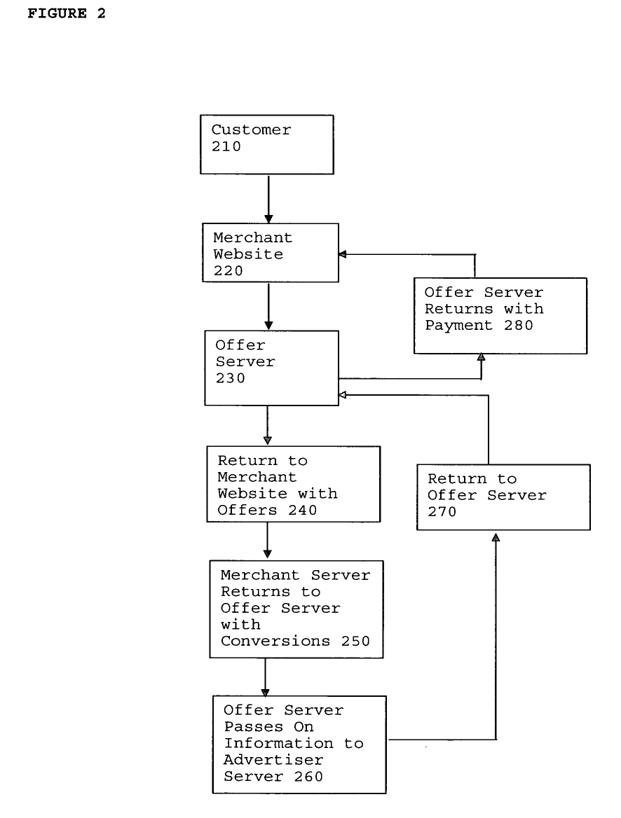

FIG. 2 begins with the Customer 210 visiting the Merchants website 220. The Merchants website 220 then proceeds to the Offer Server 230 to request code for Offers to present the Offers to the Customer. In step 240 the Offer Server returns to the Merchant Website with Offers, these Offers may or may not be customized for that particular Merchant. The Merchant Server 250 then returns to the Offer Server with the conversion, and the collected information necessary to comply with the Offer terms, as well as a unique identifier for the Customer, if the Customer took advantage of one, or many, of the presented Offers. In step 260 the Offer Server then presents the various pieces of information collected from the Customer and provided by the Merchant Server, along with unique identifying information for both the Merchant and the Customer, to the Advertiser Server. In step 207 Advertiser Server returns to the Offer Server with the payment and the unique identifiers presented by the Offer Server for reconciliation. In step 280 the Offer server then returns to the Merchant the payment and the unique identifier originally presented by the Merchant for reconciliation and proper credit to the Customers account.

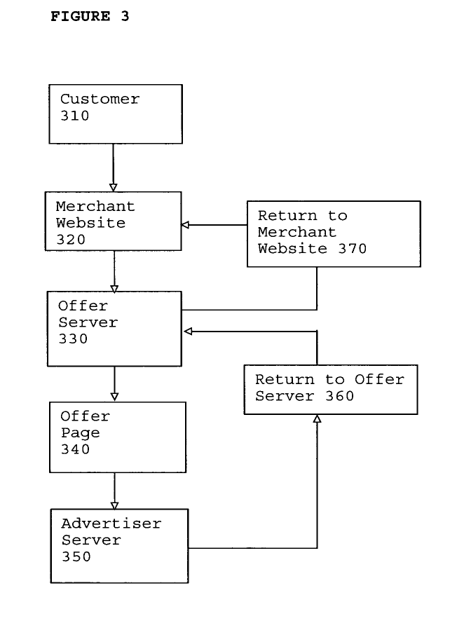

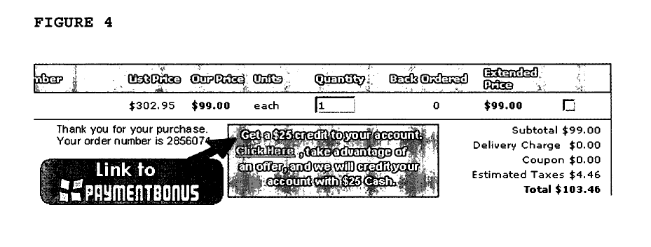

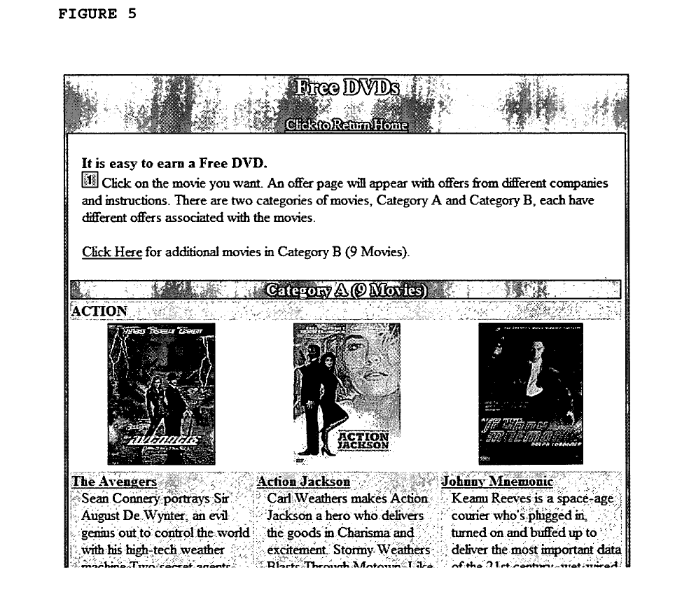

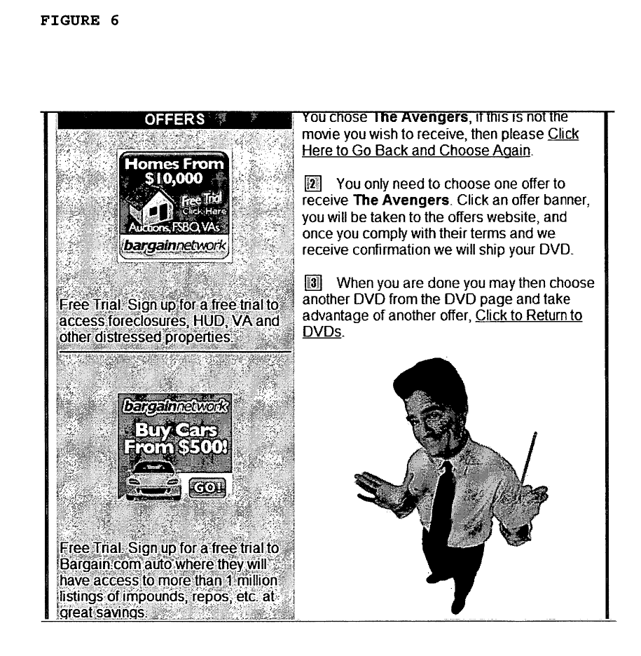

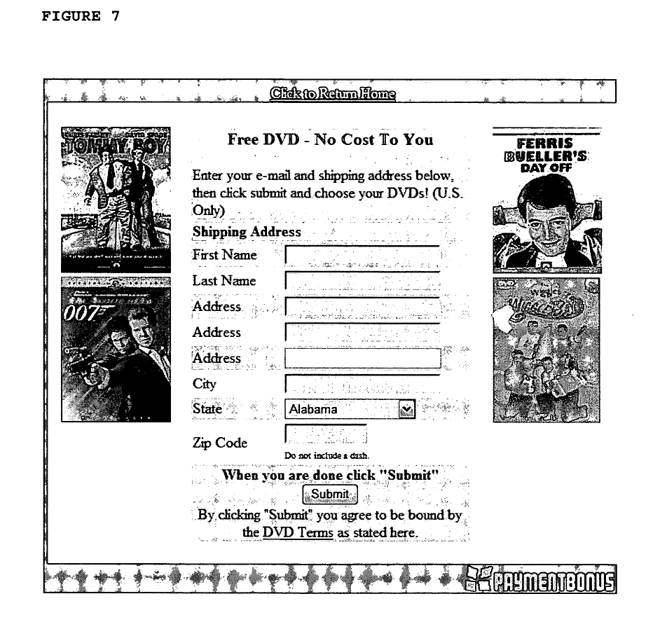

FIG. 3 begins with the Customer 310 visiting the Merchants website 320. The Merchants website then presents a link to the Customer which links to the Offer Server. Once the Customer clicks on the link, which has unique identifying information for both the Merchants website and the Customer, the link takes the Customer to the Offer Server 330 which uses the identifying information for both the Merchants website and the Customer to create a new web page with Offers in step 340, the Offer Page. Once the Customer clicks on an Offer which appears on the new web page the Customer is taken to the Advertiser Server 350 having offer terms, or a server provided by a service the Advertiser uses to host the Advertisers web pages, which passes the identifying information for both the Merchants website and the Customer to the Advertiser Server for tracking purposes. In step 360 the Advertiser Server returns to the Offer Server with the payment and the unique identifiers presented by the Offer Server for reconciliation. In step 370 the Offer server then returns to the Merchant the payment and the unique identifier originally presented by the Merchant for reconciliation and proper credit to the Customers account.

FIG. 4 is an example of an advertiser offer to an individual at a merchant site. The individual is checking out and the offer to receive cash back by taking advantage of an advertiser offer is presented.

FIG. 5 is an example of an offer to receive a large enough cash credit to the merchant account that the individual will receive full payment for merchandise, in this case a free DVD.

FIG. 6 is an example of an page presented to an individual, once an offer is redeemed by complying with the advertiser's offer requirements then the credit can be provided to the merchant or directly to the individual.

FIG. 7 is an example of obtaining unique identifiable information from a individual before presenting offers.

I claim:

1. A method of facilitating e-commerce, comprising the steps of:
presenting an advertiser offer to an individual at a merchant site operated by a merchant;
tracking the individuals acceptance of the offer, and
providing a reward to the individual.

2. A method of facilitating e-commerce as in claim 1, wherein presenting an advertiser offer to an individual at a merchant site further comprises the step of:
presenting a graphic or link that acts as acceptance of an offer when clicked by the individual.

3. A method of facilitating e-commerce as in claim 1, wherein presenting an advertiser offer to an individual at a merchant site further comprises the step of:
presenting a graphic or link that when clicked by the individual provides a new webpage having one or more offers.

4. A method of facilitating e-commerce as in claim 1, wherein providing a reward to the individual further comprises the step of:
making a transaction of money to the individual.

5. A method of facilitating e-commerce as in claim 1, wherein providing a reward to the individual further comprises the steps of:
making a transaction of money to the merchant, and
crediting the account of the individual at the merchant site.

6. A method of facilitating e-commerce as in claim 1, wherein providing a reward to the individual further comprises the steps of:
making a transaction of money to the merchant, and
debiting the current balance owed to the merchant by the individual at the merchant site.

7. A method of facilitating e-commerce as in claim 1, wherein providing a reward to the individual further comprises the steps of:
making a transaction of money to the merchant, and
providing free merchandise from the merchant to the individual.

8. A method of facilitating e-commerce as in claim 1, wherein tracking the individuals acceptance of the offer comprises the step of:
providing a unique identifier for the individual.

9. A method of facilitating e-commerce as in claim 1, wherein tracking the individuals acceptance of the offer further comprises the steps of:
providing a unique identifier for the individual, and
providing a unique identifier for the merchant.

10. A method of facilitating e-commerce as in claim 8, further comprising the steps of:
returning the unique identifier for the individual to the merchant to associate the reward to the individual.

11. A method of facilitating e-commerce as in claim 9, further comprising the steps of:
storing the unique identifier for the individual, and
storing the unique identifier for the merchant.

12. A method of facilitating e-commerce as in claim 11, further comprising the steps of:
associating the reward from the advertiser for accepting the offer with the unique identifier for the individual and the unique identifier for the merchant, and

13. A method of facilitating e-commerce as in claim 1, wherein providing a reward to the individual further comprises the steps of:
making a transaction of money to the merchant, and
crediting the individuals account the merchant site.

14. A method of facilitating e-commerce, as in claim 1 wherein presenting an advertiser offer to an individual at a merchant site is presented along with various other advertisements.

15. A method of facilitating e-commerce, as in claim 1 wherein presenting an advertiser offer to an individual at a merchant site is determined based on rules set by the Merchant.

16. A method of facilitating e-commerce, as in claim 1 wherein presenting an advertiser offer to an individual at a merchant site is determined based on rules set by the present invention.

17. A method of facilitating e-commerce, as in claim 1 wherein presenting an advertiser offer to an individual at a merchant site is determined based on rules determined by the Customers past behavior which is stored by the present invention.
